(19) United States
(12) Patent Application Publication
(10) Pub. No.: US 2025/0010971 A1
(43) Pub. Date: Jan. 9, 2025

(54) RIGID OPEN COMPOSITE PANEL

(71) Applicant: SAFRAN NACELLES, GONFREVILLE-L'ORCHER (FR)

(72) Inventors: Bertrand Léon Marie DESJOYEAUX, MOISSY-CRAMAYEL (FR); Fabrizio PAGANO, MOISSY-CRAMAYEL (FR); Mathieu François Eric PREAU, MOISSY-CRAMAYEL (FR); Mathieu VIVIENT, MOISSY-CRAMAYEL (FR)

(21) Appl. No.: 18/710,348

(22) PCT Filed: Nov. 16, 2022
(86) PCT No.: PCT/FR2022/052107

§ 371 Date: May 15, 2024

(30) Foreign Application Priority Data
Nov. 18, 2021 (FR) FR2112191

(51) Int. Cl. B64C 1/00

(52) U.S. Cl. CPC B64C 1/00; B64C 2001/0072

(57) ABSTRACT

An open composite panel for an aircraft includes a composite skin having an inner face and an outer face, and a plurality of stiffening ribs, each rib extending over the inner face of the skin in a respective direction of extension and projecting from the inner face to a top that is opposite said inner face. The plurality of ribs includes at least one reinforced rib, each reinforced rib having at least one elongate stiffening portion extending along the top of the reinforced rib, said stiffening portion including fibers extending substantially in the direction of extension of the reinforced rib.

### TECHNICAL FIELD OF THE INVENTION

The invention relates to an open composite panel, in particular intended for use in an aircraft. The invention also relates to an aircraft comprising such an open panel.

### PRIOR ART

A standard composite panel generally comprises two composite skins assembled one on either side of an intermediate structure, forming a “sandwich” structure that is particularly resistant to bending stress.

Composite skins generally comprise mineral fibers, for example carbon or glass fibers, woven or unstructured, embedded in a polymer or resin matrix.

The intermediate structure acts to assemble together the skins of the panel, and comprises a low-density porous layer, for example a foam, a honeycomb structure, or internal partitions connecting the skins and forming parallel or intersecting ribs between them.

An open composite panel has a similar structure, but only comprises one composite skin. This allows reducing the cost of the panel and simplifying its manufacturing, as well as reducing its mass, which is particularly important for an aeronautical application.

Example applications can be aircraft nacelle thrust reverser flaps, a portion of the reverser grilles, stiffened panels for the primary or secondary air stream, etc.

In order to maintain good bending stiffness, such an open panel generally comprises a structure formed of stiffening ribs extending from the inner face of the composite skin. These ribs may be oriented in a same direction or may be intersecting.

FIG. 1 illustrates a section view of such an open panel 10, comprising a skin 12 and ribs 14.

Skin 12 defines what is referred to as an “outer” face 16 and an “inner” face 18, on which ribs 14 are fixed.

Such an open panel 10 nevertheless has reduced rigidity and bending resistance compared to a panel with two skins, and therefore undergoes more deformation during stress or an impact against outer face 16.

Such deformation can generate the appearance of cracks or a partial separation of one or more ribs 14, which then fulfill their stiffening role less effectively. In addition, as the ribs are arranged on the inner face of panel 10, and are therefore hidden from view, this damage is not easily detectable.

Solutions involving an increase in the rigidity of the ribs are proposed in documents EP 2,367,681 and US 787,927 which suggest adding a reinforcing frame inside a hollow rib, and in document U.S. Pat. No. 8,403,263 which proposes superimposing two ribs nested one inside the other. These approaches greatly complicate the manufacturing of the panel, by requiring the manufacturing of ribs having specific geometries. They also significantly increase the mass of the panel, which is undesirable, particularly in aeronautical applications.

### PRESENTATION OF THE INVENTION

The invention aims to remedy these disadvantages, by proposing an open panel having increased bending stiffness and better resistance to deformation, making it possible to significantly reduce the mass of the panel and simplify its manufacture.

For this purpose, the invention relates to an open composite panel comprising:
a composite skin having an inner face and an outer face,
a plurality of stiffening ribs, each rib extending from the inner face of the skin to a top that is opposite said inner face, each rib extending in a respective direction of extension, characterized in that the plurality of ribs comprises at least one reinforced rib, each reinforced rib comprising at least one elongate stiffening portion extending along the top of the reinforced rib, said stiffening portion comprising fibers extending substantially in the direction of extension of the reinforced rib.

Such a panel has a bending resistance that is increased by the stiffening portions, which gives it better resistance against impacts on the outer face of the panel. The stiffening portions are simple to add to the panel, and only slightly increase the total mass of the panel. “Extending substantially in a direction” is understood to mean forming an angle of less than 10° with this direction, preferably less than 5°.

The fibers of the stiffening portion may be long fibers, having an average length that is at least 5 times greater than a width of the rib and which may reach the total length of the rib.

The fibers of the stiffening portion may be fibers of high Young's modulus, having an average elastic modulus on the order of 70,000 MPa for glass fibers, and between 235,000 MPa and 550,000 MPa for carbon fibers.

The stiffening portion is rigid, in particular meaning it has an elastic stiffness that is greater than or equal to that of the material composing the ribs.

The stiffening portion may be made of a composite material comprising fibers embedded in a matrix.

The fibers may be glass fibers, carbon fibers, Kevlar fibers, or other types of fibers.

The matrix may be of the thermosetting type, for example selected from the family of epoxy or poly-bismaleimide resins, or of the thermoplastic type, for example selected from the family of poly ether ether ketones.

The stiffening portion may extend over the entire length of the rib, or over only a portion of the rib.

Preferably, the stiffening portion extends over at least 50% of the length of the rib.

A reinforced rib may extend in a rectilinear manner over the surface of the skin, or in a serpentine manner.

The reinforced ribs may extend in at least two different directions of extension, forming between them an angle of between 15° and 165° and intersecting.

Said angle may be between 45° and 135°.

Several reinforced ribs may be joined, forming Y-shaped connections or T-shaped connections. They may also intersect to form angles of 15 to 90°.

This feature greatly increases the stiffness and resistance of the panel.

For each reinforced rib, the area of the cross-section of the fibers of the stiffening portion, in a plane perpendicular to the direction of extension, may be greater than or equal to 5% of the area of the cross-section, in the plane perpendicular to said direction of extension, of the skin fibers which extend substantially in said direction of extension and which are located in a portion of the skin that is between two neighboring ribs of the reinforced rib.

This feature gives the stiffening portion significant bending stiffness, so as to further stiffen the rib and reinforce the panel.

For each reinforced rib, the area of the cross-section of the fibers of the stiffening portion, in a plane perpendicular to the direction of extension, may be greater than or equal to 10% of the area of the cross-section, in the plane perpendicular to said direction of extension, of the skin fibers which extend substantially in said direction of extension and which are located in a portion of the skin that is between two neighboring ribs of the reinforced rib.

The neighboring ribs of the reinforced rib are the ribs closest to said reinforced rib and extending parallel to said reinforced rib.

The cross-section of each stiffening portion, in a plane perpendicular to the direction of extension, may have an elliptical, rectangular, or triangular shape.

The panel may comprise at least one attaching element covering one of the reinforced ribs, each attaching element having an elongate shape in the direction of extension of the reinforced rib and a U-shaped cross-section, the attaching element being attached to the stiffening portion and to sides of the rib.

The attaching element may be attached by gluing to the stiffening portion and to the sides of the rib.

This feature increases the strength of the attachment of the stiffening portion to the top of the rib.

Each attaching element may comprise intersecting and/or disordered fibers.

This feature gives the attaching element good tear resistance, in all directions.

At least one of the reinforced ribs may extend along a lateral edge of the skin.

One of the reinforced ribs may extend along each lateral edge of the skin.

Each of the reinforced ribs extending along a lateral edge of the skin may comprise a reinforcing element of the aforementioned type.

These features make it possible to increase the stiffness of the panel at the reinforced edge(s), which improves the mechanical resistance of the panel as a whole.

The stiffening portion may extend over the top of the rib, at the side that is opposite the skin in the thickness direction.

This feature improves the detachment resistance of the rib, in addition to facilitating the attachment of the stiffening portion.

The stiffening portion may be external to the sides of the rib.

The stiffening portion may be attached, for example by gluing, to an outer surface of the top.

This feature allows simple attachment of the stiffening portion.

The stiffening portion may be composed of an organic matrix composite material.

This feature gives the stiffening portion satisfactory stiffness and mechanical strength for an application concerning a structural panel.

The stiffening portion may be attached to the top of the rib by said matrix, which permeates the top and allows attachment while it is hardening.

This feature simplifies assembly of the rib and ensures a close connection between the top of the rib and the stiffening portion.

The invention also relates to an aircraft comprising an open panel of the aforementioned type.

Said aircraft may be an airplane.

### BRIEF DESCRIPTION OF FIGURES

FIG. 1 is a schematic cross-section view of an open panel of the state of the art,

FIG. 2 is a schematic cross-section view of an open panel according to a first embodiment of the invention,

FIG. 3 is a schematic view towards an inner face of an open panel according to a second embodiment of the invention, and

FIG. 4 is a schematic cross-section view of an open panel according to a third embodiment of the invention.

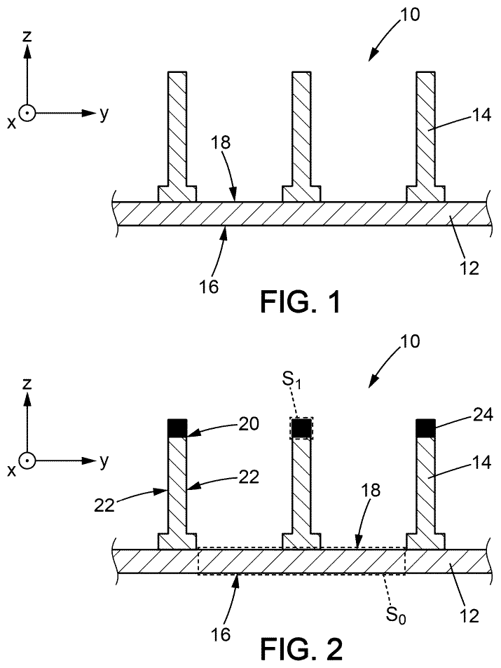

### DETAILED DESCRIPTION OF THE INVENTION

FIG. 2 illustrates a section view of an open panel 10 according to a first embodiment of the invention, comprising a composite skin 12 and ribs 14.

Skin 12 extends along a plane of extension XY, and defines an outer face 16 and an inner face 18 which are spaced apart from each other along a thickness direction Z that is perpendicular to plane of extension XY.

Outer face 16 is for example intended to face a passenger compartment and be visible, while inner face 18 is not visible once panel 10 is in place.

Skin 12 is for example made from a composite material comprising fibers, for example carbon and/or glass fibers, embedded in a matrix comprising a polymer and/or a resin. The fibers may be interwoven or disordered in the matrix.

Ribs 14 are fixed on inner face 18 and project from inner face 18 in the thickness direction Z, to respective tops 20 of ribs 14.

Each rib 14 extends over inner face 18 of skin 12, in a respective direction of extension. For example, the ribs all extend in a same direction of extension X, parallel to each other.

Ribs 14 may be regularly spaced apart along a transverse direction Y that is perpendicular to the direction of extension X and to the thickness direction Z.

Each rib comprises two sides 22 each extending between inner face 18 and top 20 of rib 14, the sides being opposite each other in the transverse direction Y.

At least one of ribs 14 is a reinforced rib, adapted to present greater stiffness and to reinforce panel 10.

All ribs 14 of panel 10 may be such reinforced ribs.

Each reinforced rib comprises at least one elongate stiffening portion 24 extending along top 20 of the reinforced rib.

In particular, the stiffening portion 24 extends over the top of rib 14, on the rib surface that is opposite skin 12 in the thickness direction Z.

The stiffening portion 24 is external to sides 18 of rib 14. It is fixed, for example by gluing, on an outer surface of top 20.

The stiffening portion 24 is an elongate rigid structure extending along the direction of extension X of the reinforced rib, in the shape of a long thin rectangle, made of a rigid material, which in particular has an elastic stiffness that is greater than or equal to that of the component material of ribs 14.

The stiffening portion 24 comprises fibers extending substantially in the direction of extension X.

The stiffening portion 24 also comprises a matrix, comprising for example a polymer and/or a resin, in which said fibers are embedded.

In particular, the stiffening portion 24 is composed of an organic matrix composite material.

The stiffening portion 24 may be attached to top 20 of rib 14 by said matrix, which permeates top 20 and allows attachment while it is hardening.

The fibers of the stiffening portion 24 may be long fibers, having an average length that is at least 5 times greater than a width of the rib and able to reach the total length of the rib.

The fibers of the stiffening portion 24 may be fibers of high Young's modulus, having an average elastic modulus on the order of 70,000 MPa for glass fibers, and between 235,000 MPa and 550,000 MPa for carbon fibers.

As the stiffening portion is formed using a composite resulting from encapsulating fibers in a matrix, the stiffening portion has an overall modulus that is approximately half that of the fibers alone.

The stiffening portion is integral with top 20 of rib 14, and may be connected to top 20 of rib 14 by the polymer matrix of the composite that forms the stiffening portion 24.

The body of rib 14, located between skin 12 and the stiffening portion 24, may be composed of composites having oriented and organized fibers such as fabrics.

In another embodiment, the body of rib 14 may be composed of composites based on discontinuous and randomly distributed fibers.

The stiffening portion 24 has a rectangular cross-section in a plane perpendicular to the direction of extension X of rib 14.

Alternatively (not shown), the stiffening portion 24 has a triangular, elliptical, or circular cross-section.

For each reinforced rib 14, an area of a cross-section S₁ of the fibers of stiffening portion 24, in a plane perpendicular to the direction of extension X, is greater than or equal to 10% of an area of a cross-section S₀, in the plane perpendicular to the direction of extension X, of the fibers extending substantially in the direction of extension The neighboring ribs 14 to the reinforced rib are the ribs closest to the reinforced rib and extending parallel to the reinforced rib.

Cross-section S₀ extends between the bases of the two neighboring ribs 14 of the reinforced rib, across the entire thickness of skin 10 in the thickness direction Z.

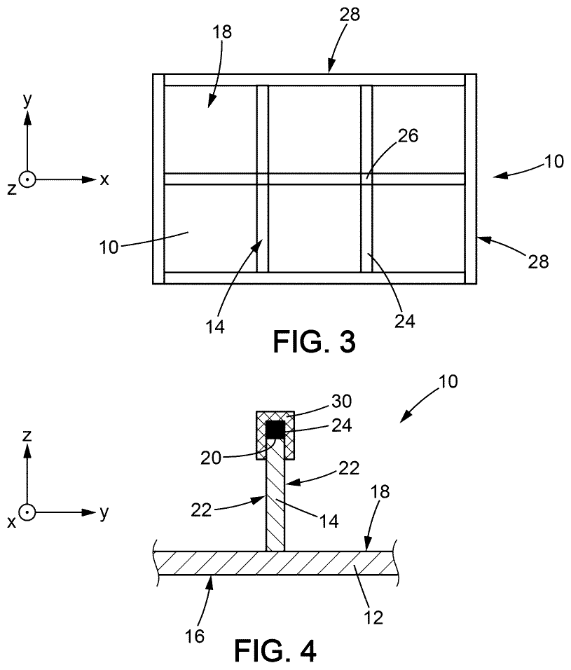

FIG. 3 represents a panel 10 according to a second embodiment of the invention, viewed towards inner face 18.

Panel 10 comprises stiffening ribs 14 extending in two directions of extension X, Y that are different from each other, in particular three ribs 14 extending in a first direction of extension X and four ribs 14 extending in a second direction of extension Y.

The first direction of extension X and the second direction of extension Y form between them an angle of between 15° and 165°, and in particular equal to 90° in the example shown.

The ribs 14 are all reinforced ribs comprising a stiffening portion 24 extending along their respective tops. The fibers of stiffening portions 24 extend substantially in the respective direction of extension X, Y of rib 14 carrying the stiffening portion 24.

The ribs 14 intersect at at least one point of intersection 26, and the two ribs 14 forming point of intersection 26 are integral with one another thereat, which increases the rigidity of panel 10. The two ribs 14 are for example glued to each other at point of intersection 26.

The fibers of the stiffening portions 24 of the ribs 14 forming point of intersection 26 may intersect at the point of intersection 26, which further improves the rigidity of panel 10.

Skin 12 defines lateral edges 28, along which the reinforced ribs 14 extend.

Reinforced ribs 14 extending along lateral edges 28 improve the rigidity of panel 10.

Alternatively, only part of the lateral edges 28 of the skin 12 has a reinforced rib 14.

FIG. 4 illustrates a partial section view of an open panel 10 according to a third embodiment of the invention.

Panel 10 comprises ribs 14 as described above, extending over the inner face 18 of the skin 12 in respective directions of extension X.

Each rib 14 comprises sides 22 which are opposite each other in a transverse direction Y, and a top 20.

At least one of the ribs 14 is reinforced and comprises a stiffening portion 24 along the top 20.

At least one of reinforced ribs 14 further comprises an attaching element 30 arranged above said stiffening portion 24 and extending against the sides 22, on both sides of the top 20 and the stiffening portion 24.

The attaching element 30 has an elongate shape in the direction of extension X and extends for example along the entire length of the stiffening portion 24. It is integral with the stiffening portion 24 and the sides 22, to which it is for example attached by gluing or on which it is overmolded.

The attaching element 30 has for example a U-shaped cross-section in a plane orthogonal to the direction of extension X.

The attaching element 30 may comprise fibers, in particular fibers extending in the plane orthogonal to the direction of extension X, for example interwoven or disordered fibers.

The attaching element 30 increases the strength of the attachment of the stiffening portion 24 to the top 20, and thus improves the durability of panel 10.

All features of the described embodiments may freely be combined with each other, as long as they are technically compatible.

The panels 10 described have better resistance to impacts and to bearing forces coming from the direction of outer face 16, due to the increased rigidity of ribs 14 which reduces the risk of tearing or separation of said ribs 14. However, they retain an architecture that is lightweight and simple to manufacture.

1. An open composite panel (10) comprising:
a composite skin (12) having an inner face (18) and an outer face (16),
a plurality of stiffening ribs (14), each rib (14) extending from the inner face (18) of the skin (12) to a top (20) that is opposite said inner face (18), each rib (14) extending in a respective direction of extension (X),
wherein the plurality of ribs (14) comprises at least one reinforced rib (14), each reinforced rib (14) comprising at least one elongate stiffening portion (24) extending along the top (20) of the reinforced rib (14), said stiffening portion (24) comprising fibers extending substantially in the direction of extension (X) of the reinforced rib (14).

2. The panel according to claim 1, wherein the reinforced ribs (14) extend in at least two different directions of extension (X, Y), forming between them an angle of between 15° and 165° and intersecting.

3. The panel according to claim 1, wherein, for each reinforced rib (14), an area of a cross-section (S₁) of the fibers of the stiffening portion (24), in a plane perpendicular to the direction of extension (X), is greater than or equal to 5% of an area of a cross-section (S₀), in the plane perpendicular to said direction of extension (X), of fibers of the skin (12) which extend substantially in said direction of extension (X) and which are located in a portion of the skin (12) that is between two neighboring ribs (14) of the reinforced rib (14).

4. The panel according to claim 1, wherein a cross-section of each stiffening portion (24), in a plane perpendicular to the direction of extension (X), has an elliptical, rectangular, or triangular shape.

5. The panel according to claim 1, wherein the panel (10) comprises at least one attaching element (30) covering one of the reinforced ribs (14), each attaching element (30) having an elongate shape in the direction of extension (X) of the reinforced rib (14) and a U-shaped cross-section, the attaching element (30) being attached to the stiffening portion (24) and to sides (22) of the rib (14).

6. The panel according to claim 5, wherein each attaching element (30) comprises intersecting and/or disordered fibers.

7. The panel according to claim 1, wherein at least one of the reinforced ribs (14) extends along a lateral edge (28) of the skin (12).

8. The panel according to claim 7, wherein one of the reinforced ribs (14) extends along each lateral edge (28) of the skin (12).

9. An aircraft comprising a panel (10) according to claim 1.

10. An aircraft comprising a panel (10) according to claim 2.

11. The panel according to claim 2, wherein, for each reinforced rib (14), an area of a cross-section (S₁) of the fibers of the stiffening portion (24), in a plane perpendicular to the direction of extension (X), is greater than or equal to 5% of an area of a cross-section (S₀), in the plane perpendicular to said direction of extension (X), of fibers of the skin (12) which extend substantially in said direction of extension (X) and which are located in a portion of the skin (12) that is between two neighboring ribs (14) of the reinforced rib (14).

12. The panel according to claim 11, wherein a cross-section of each stiffening portion (24), in a plane perpendicular to the direction of extension (X), has an elliptical, rectangular, or triangular shape.

13. The panel according to claim 11, wherein the panel (10) comprises at least one attaching element (30) covering one of the reinforced ribs (14), each attaching element (30) having an elongate shape in the direction of extension (X) of the reinforced rib (14) and a U-shaped cross-section, the attaching element (30) being attached to the stiffening portion (24) and to sides (22) of the rib (14).

14. The panel according to claim 13, wherein each attaching element (30) comprises intersecting and/or disordered fibers.

15. The panel according to claim 11, wherein at least one of the reinforced ribs (14) extends along a lateral edge (28) of the skin (12).

16. The panel according to claim 15, wherein one of the reinforced ribs (14) extends along each lateral edge (28) of the skin (12).
